(19) United States
(12) Patent Application Publication
(10) Pub. No.: US 2026/0313068 A1
(43) Pub. Date: Oct. 8, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: Naoki SUMI, Kanagawa (JP); Takayuki YAMADA, Kanagawa (JP); Yoshinori MIZOGUCHI, Tokyo (JP); Yuto KAJIWARA, Kanagawa (JP); Yuki ISHIDA, Kanagawa (JP); Kazufumi KONDO, Kanagawa (JP); Kosuke SASAKI, Kanagawa (JP); Shinjiro HORI, Kanagawa (JP)

(21) Appl. No.: 19/570,533

(22) Filed: Mar. 18, 2026

(30) Foreign Application Priority Data
Apr. 8, 2025 (JP) 2025-063937

(51) Int. Cl. H04N 1/60; H04N 1/00; H04N 1/40

(52) U.S. Cl. CPC H04N 1/603; H04N 1/00822; H04N 1/40068; H04N 2201/0081

(57) ABSTRACT

An image processing apparatus includes: a reading control unit configured to control a reading apparatus to read a document; a model execution unit configured to cause a machine learning model to execute a process using a learned parameter and taking a read image of a document as an input, wherein the learned parameter is a model parameter learned with an input image having a color shift and a correct image obtained by reducing a source image having a higher resolution than the input image; wherein the color shift results from a shift in reading position between light sources of a plurality of colors; and an obtaining unit configured to obtain an image output from the machine learning model in which the color shift has been reduced as compared to the read image.

### BACKGROUND

### Field of the Technology

The present disclosure relates to an image processing apparatus, an image processing method, and a storage medium.

### Description of the Related Art

As apparatuses that read a document into the form of an image, there are color copying machines, color multi-function peripherals, scanners, and so on. Some apparatuses that read a document into the form of an image may use a line sensor in which light receiving elements are linearly arrayed, and move the line sensor or the document in a moving direction that intersects (perpendicularly) the array direction of the light receiving elements. In a case of reading a document with a line sensor that moves along the moving direction or reading a document that is moved along the moving direction with a fixed line sensor, a color shift may occur. The color shift is a shift in color resulting from a shift in the reading position of the line sensor.

Japanese Patent Laid-Open No. 2021-141430 discloses a technique that generates correction data using one of N pieces of first-type-document reading data obtained by a first reading process and reference image data in order to reduce the positional shift between a plurality of color components.

### SUMMARY

In the present disclosure, there is a demand to properly reduce a color shift.

An image processing apparatus according to an aspect of the present disclosure includes: a reading control unit configured to control a reading apparatus to read a document; a model execution unit configured to cause a machine learning model to execute a process using a learned parameter and taking a read image of the document read by the reading apparatus as an input, wherein the learned parameter is a model parameter learned with an input image having a color shift and a correct image obtained by reducing a source image having a higher resolution than the input image; wherein the color shift results from a shift in reading position between light sources of a plurality of colors; and an obtaining unit configured to obtain an image output from the machine learning model as a result of executing the process with the read image of the document as an input, the image output from the machine learning model being obtained as an image in which the color shift has been reduced as compared to the read image.

Features of the present disclosure will become apparent from the following description of embodiments with reference to the attached drawings. The following description of embodiments are described by way of example.

### BRIEF DESCRIPTION OF THE DRAWINGS

FIG. 1 is a view illustrating an example of an exterior configuration of a reading apparatus;

FIG. 2 is a diagram illustrating an example of a configuration of a reading unit;

FIG. 3 is a block diagram illustrating an example of a configuration of the reading apparatus;

FIG. 4 is a flowchart illustrating an example of image processing to be executed by an image processing unit;

FIG. 5 is a diagram illustrating an example of a machine learning model;

FIG. 6 is a diagram for describing a convolution process;

FIG. 7 is a diagram illustrating an example of a learning setting screen;

FIG. 8 is a flowchart illustrating an example of a learning process;

FIG. 9 is a flowchart illustrating an example of a training data creation process;

FIG. 10 is a schematic diagram of a case of reading one pixel at 150 dpi;

FIG. 11 is a schematic diagram of a case reading one pixel at 1200 dpi;

FIG. 12 is a flowchart illustrating an example of a process performed by the reading apparatus;

FIG. 13 is a schematic diagram of a convolutional neural network (CNN) model used in a second embodiment;

FIG. 14 is a diagram illustrating an example of a learning setting screen in a third embodiment;

FIG. 15 is a flowchart illustrating an example of a training data creation process in the third embodiment;

FIG. 16 is a diagram illustrating an example of a re-learning setting screen in a fourth embodiment;

FIG. 17 is a block diagram illustrating an example of a configuration of the reading apparatus in a case where it is a copying apparatus; and

FIG. 18 is a diagram illustrating an example of a user interface (UI) screen for correction modes.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. Incidentally, an identical reference numeral is assigned to an identical constituent and an explanation thereof is made.

### First Embodiment

### Overview

There is a case where a scan is performed while the channel sequence in which light sources emit light is changed as RGB→GBR→BRG, and only the middle channel among the three channels is collected to form one image. In this case, unread spaces may be present. This leads to a problem that, in a case where a document includes a fine line or a dot in such a space, the information present in that space is lost. In the present embodiment, an example of properly reducing a color shift will be described.

### <Image Reading Apparatus>

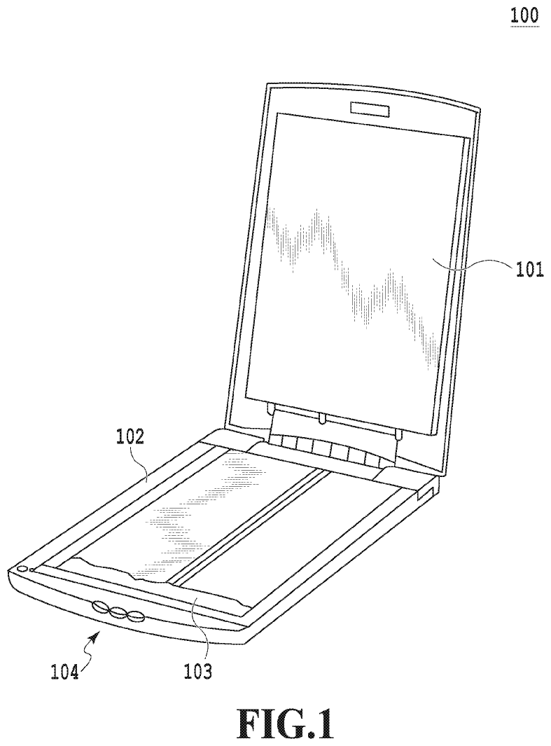

FIG. 1 is a view illustrating an example of an exterior configuration of a reading apparatus 100. The reading apparatus 100 includes a document plate cover 101, a document plate 102, a reading unit 103, and an operation part 104. The document plate cover 101 is a member that holds down a document placed on the document plate 102. The document plate 102 is a plate to place a document. The reading unit 103 is capable of reading the document placed on the document plate 102. The operation part 104 is an operation device operable by the user. In response to an operation by the user, the operation part 104 outputs information for executing an action corresponding to that operation.

In a case of reading a document with the reading apparatus 100, the user places the document on the document plate 102, holds down that document with the document plate cover 101, and then operates the operation part 104. The operation part 104 is provided with a plurality of buttons. Some of the plurality of buttons are a first read button, a second read button, and a third read button. The first read button is a button for executing a high-resolution color scan mode being a mode for performing color reading at a high resolution. The second read button is a button for executing a low-resolution color scan mode being a mode for performing color reading at a low resolution. The third read button is a button for executing a high-resolution monochrome scan mode being a mode for performing monochrome reading at a high resolution. The user presses a button corresponding to a scan mode which the user desires. In response to this press, the reading unit 103 starts reading the document.

In the high-resolution color scan mode, the reading apparatus 100 can read a document at a high resolution in color. In the low-resolution color scan mode, the reading apparatus 100 can read a document at a low resolution in color. In the high-resolution monochrome scan mode, the reading apparatus 100 can read a document at a high resolution in monochrome.

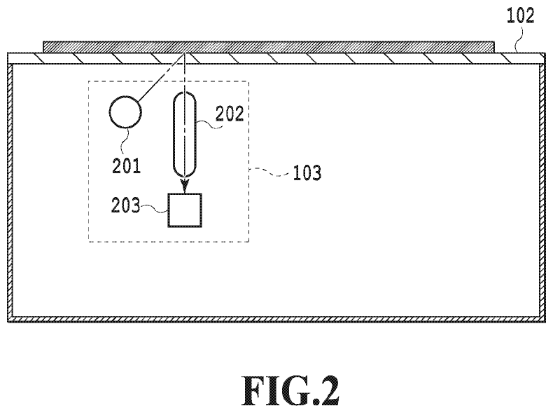

FIG. 2 is a diagram illustrating an example of a configuration of the reading unit 103. The reading unit 103 is movable in a main scanning direction and a sub scanning direction intersecting the main scanning direction. The reading unit 103 is moved by motors (not illustrated). The reading unit 103 includes a light source 201, a rod lens array 202, and a sensor 203. The reading unit 103 applies light from the light source 201 onto a document placed on the document plate 102, and light with a diffusely reflected component reflected by the document passes through the rod lens array 202. The sensor 203 detects the light having passed through the rod lens array 202 and performs photoelectrically converts the detected light. The sensor 203 outputs a signal obtained by the photoelectric conversion.

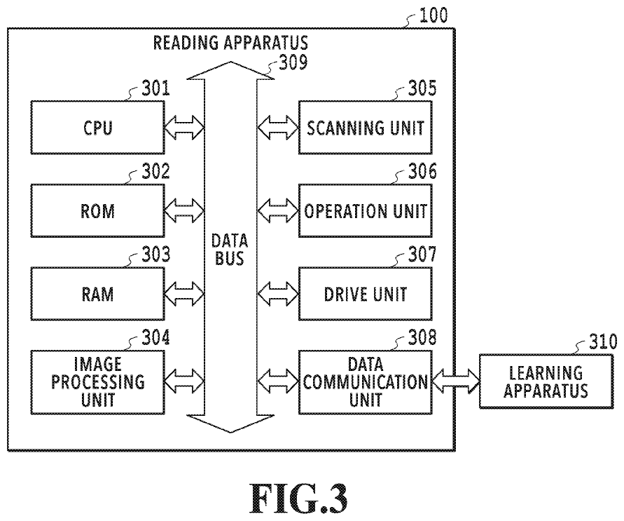

FIG. 3 is a block diagram illustrating an example of a configuration of the reading apparatus 100. The reading apparatus 100 includes a central processing unit (CPU) 301, a read-only memory (ROM) 302, a random-access memory (RAM) 303, an image processing unit 304, a scanning unit 305, an operation unit 306, a drive unit 307, a data communication unit 308, and a data bus 309.

The CPU 301 is a processing unit for implementing various functions of the reading apparatus 100. The CPU 301 includes at least one processor. The CPU 301 executes various processes by executing programs or activating hardware. The CPU 301 executes the programs by reading out the programs to the RAM 303 and expanding them.

The ROM 302 stores various pieces of data. For example, the ROM 302 stores programs to be executed by the CPU 301. Also, the ROM 302 stores various values, tables, mathematical equations, and the like to be used in image processing, such as shading correction. The various values to be used in the image processing include learned parameters. The learned parameters are model parameters obtained by learning. The model parameters are parameters to be used by machine learning models.

The RAM 303 is used as a work memory for the CPU 301 and the like. For example, the RAM 303 temporarily stores various pieces of information in a case where the CPU 301 executes programs or in a case where the image processing unit 304 performs image processing.

The image processing unit 304 performs image processing such as correction of image data generated by the scanning unit 305 or image encoding. The image data correction includes shading correction and gamma correction.

The scanning unit 305 obtains the signal output from the reading unit 103. This signal includes, for example, values indicating red (R), green (G), and blue (B) analog luminances. The scanning unit 305 executes an analog-to-digital (AD) conversion process on the obtained signal based on the scan mode designated by the user, and generates image data corresponding to the scan mode.

The operation unit 306 monitors each of the plurality of buttons included in the operation part 104 (FIG. 1). In response to detecting any of the plurality of buttons, the operation unit 306 outputs information corresponding to the detected button. For example, in response to detecting a press on any of the first read button, the second read button, and the third read button, the operation unit 306 outputs an instruction to perform reading in the scan mode corresponding to the detected button.

The drive unit 307 is a unit that causes the reading unit 103 to operate. The drive unit 307 includes, for example, a driver circuit and the like for controlling the motors that drive the reading unit 103.

The data communication unit 308 is an interface that receives and outputs data from and to one or more external devices. One of the external devices is a learning apparatus 310. The learning apparatus 310 is an apparatus that causes a machine learning model to execute processes. The learning apparatus 310 has hardware, such as a CPU, a graphics processing unit (GPU), an application-specific integrated chip (ASIC), and a field-programmable gate array (FPGA), capable of executing learning processes. Examples of the learning apparatus 310 include a personal computer, a server, a smartphone, a printer, and the like.

The data bus 309 communicably connects blocks to one another. The blocks include the CPU 301, the ROM 302, the RAM 303, the image processing unit 304, the scanning unit 305, the operation unit 306, the drive unit 307, and the data communication unit 308.

Note that the reading apparatus 100 includes the image processing unit 304 in the example of FIG. 3, but may not include the image processing unit 304. In a case where the image processing unit 304 does not include the reading apparatus 100, the CPU 301, for example, performs the image processing to be executed by the image processing unit 304. Alternatively, an information processing apparatus connected through the data communication unit 308 may perform the image processing to be executed by the image processing unit 304. This information processing apparatus may be a personal computer. Alternatively, the information processing apparatus may be a server that provides a service.

Also, in the present embodiment, the reading apparatus 100 is a flatbed reading apparatus, but may be a sheet-fed reading apparatus. In the case of a flatbed reading apparatus, the reading unit 103 moves relative to a fixed document. In the case of a sheet-fed reading apparatus, a document is moved related to a fixed reading unit. In this case, the document is moved by an automatic document feeder (ADF).

### <Image Processing>

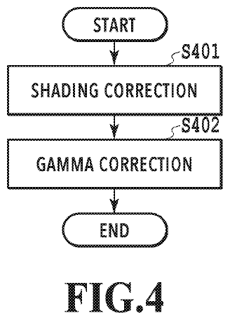

FIG. 4 is a flowchart illustrating an example of the image processing to be executed by the image processing unit 304. The flowchart of FIG. 4 is executed each time the operation unit 306 detects a press on any of the buttons corresponding respectively to the plurality of scan modes. Note that each symbol “S” in the following description of the flowchart means a step.

In S401, the image processing unit 304 performs shading correction on image data generated by the scanning unit 305. The shading correction corrects variation of the image capturing element (sensor 203). For example, in the shading correction, correction data for correcting uneven lighting or lens characteristics is generated based on white reference data and black reference data prepared in advance. The image data is corrected using this correction data to adjust unevenness in the brightness of the image in the image data. After the shading correction is performed, the processing proceeds to S402.

In S402, the image processing unit 304 performs gamma correction on the image data subjected to the shading correction. The gamma correction corrects the luminance values of the image such that the rendered image will be appear natural to the human eye. For example, in the gamma correction, the image data subjected to the shading correction is corrected using a gamma value table held in advance in the ROM 302 to adjust the brightness of the whole image in the image data.

### <Machine Learning>

Next, machine learning for reducing color shift will be described. The machine learning involves a learning process and an estimation process. The learning process is a process of learning model parameters of a machine learning model. The estimation process is a process of causing the machine learning model to execute a process using the learned parameters. In the present embodiment, an image generation model is used as the machine learning model. The image generation model is a machine learning model that outputs images.

### <<Machine Learning Model>>

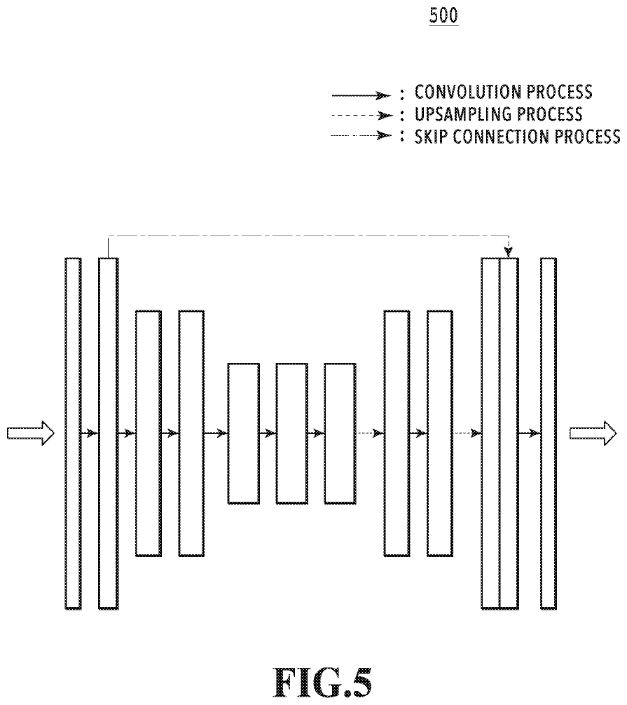

FIG. 5 is a diagram illustrating an example of a machine learning model 500. The machine learning model 500 is an image generation model. Moreover, the machine learning model 500 is a machine learning model based on a convolutional neural network (CNN model).

In the example of FIG. 5, each rectangle represents image data. The length of this rectangle in the vertical direction represents the number of pixels in the image data. The larger the number of pixels, the longer the vertical length of the rectangle representing the image data. The length of the rectangle in the horizontal direction represents the number of channels in the image data. The larger the number of channels, the longer the horizontal length of the rectangle representing the image data.

Also, in the example of FIG. 5, each arrow represents a process. Specifically, each solid arrow represents a convolution process. Each dashed arrow represents an upsampling process. The long dashed short dashed arrow represents a skip connection process. The convolution process includes a calculation that moves a filter over the image to derive the sum of products between the portion of the image on which the filter is placed and the filter. Details of this convolution process will be described later. The upsampling process is a process that increases the number of pixels of the image data. In the present embodiment, the upsampling process is executed using bilinear interpolation but is not limited to this. For example, the upsampling process may be executed using different interpolation such as nearest interpolation or bicubic interpolation. Alternatively, the upsampling process may be executed using deconvolution. The skip connection process is a process that connects the output of a layer to a later layer. Specifically, it connects the image data before upsampling processes and the image data after the upsampling processes in the channel direction.

Image data with three channels, namely R, G and B channels, for example, is input into the machine learning model 500. In response to the input of the image data, the machine learning model 500 starts processing. Specifically, the machine learning model 500 executes a first convolution process on the input image data. Then, the image data obtained by the first convolution process is subjected to a second convolution process involving downsampling. Then, the image data obtained by the second convolution process is subjected to a third convolution process. Then, the image data obtained by the third convolution process is subjected to a fourth convolution process involving downsampling. Then, the image data obtained by the fourth convolution process is subjected to a fifth convolution process and a sixth convolution process in this order. Then, the image data obtained by the sixth convolution process is subjected to an upsampling process. Then, the image data obtained by the upsampling process is subjected to a seventh convolution process. Then, the image data obtained by the seventh convolution process is subjected to an upsampling process. Then, the image data obtained by the upsampling process is subjected to a skip connection process. In the example of FIG. 5, the image data obtained by the first convolution process is connected to the image data obtained by the upsampling process. Then, the image data obtained by the skip connection process is subjected to an eighth convolution process. This image data obtained by the eighth convolution process is output as the result of the processing by the machine learning model 500.

As described above, the structure of the machine learning model 500 has eight convolution process layers, two upsamplings, and one skip connection, but may be a different structure. For example, at least one of the number of layers and the number of channels may be increased. While increasing at least one of the number of layers and the number of channels increases the processing load, it is expected to improve accuracy.

### <<Convolution Process>>

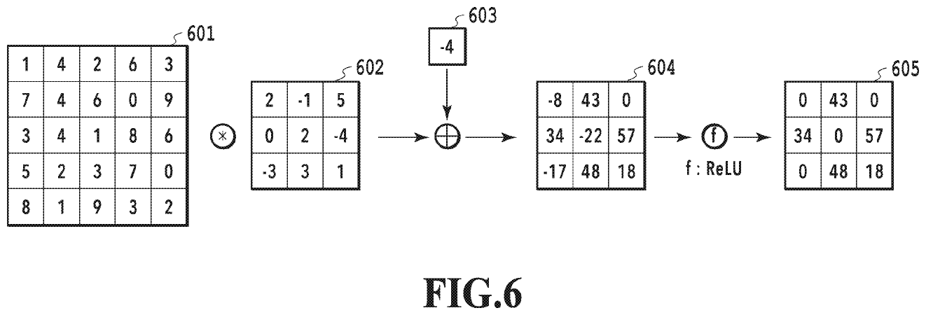

FIG. 6 is a diagram for describing a convolution process. In a convolution process, first, a convolution calculation is performed with input data 601 and weight 602. Then, a bias 603 is added to the result of this convolution calculation to obtain intermediate data 604. Then, the intermediate data 604 is converted by an activation function f to obtain output data 605. The activation function f is the rectified linear unit (ReLU), but an activation function other than ReLU may be used instead. In a case where the activation function f is ReLU, all values less than 0 will be 0 in the output data 605. Note that the weight 602 and the bias 603 are model parameters, are learned in the learning process. The weight 602 is also called a filter or a window.

In the example of FIG. 6, the numbers of channels in the input data 601, the intermediate data 604, and the output data 605 are all one but are not limited to this. Also, the size of the weight 602 is 3×3 but is not limited to this. For example, in a case where the number of channels in the input data 601 is M, the number of channels in the intermediate data 604 is N, and the size of the weight 602 is K×K, the weight 602 is a (K×K×M×N)-dimensional matrix. In this case, the bias 603 is an N-dimensional vector.

Also, in the example of FIG. 6, the sizes of the input data 601 and the intermediate data 604 are different but can be made equal. For example, the sizes of the input data 601 and the intermediate data 604 will be equal by performing a padding process on the input data 601 and performing a convolution calculation with the result of that padding process and the weight 602. The padding process is a process that adds pixels with a value 0 or the like around the input data 601.

Also, in the example of FIG. 6, the stride in the convolution process is 1, but may be other than 1. Note that the stride is the width across which the filter (weight 602) is moved. For example, in a case where the stride is 2, the input data 601 is subjected to a convolution calculation in a pixel-by-pixel manner with the weight 602. In this case, the number of pixels of the intermediate data 604 will be ¼ of the number of pixels of the input data 601. This makes it possible to implement the convolution processes involving downsampling, each of which is one of the processes by the machine learning model 500 described above. Note that the downsampling does not need to a convolution process. For example, it may be downsampling by max pooling.

### <<Learning Setting Screen>>

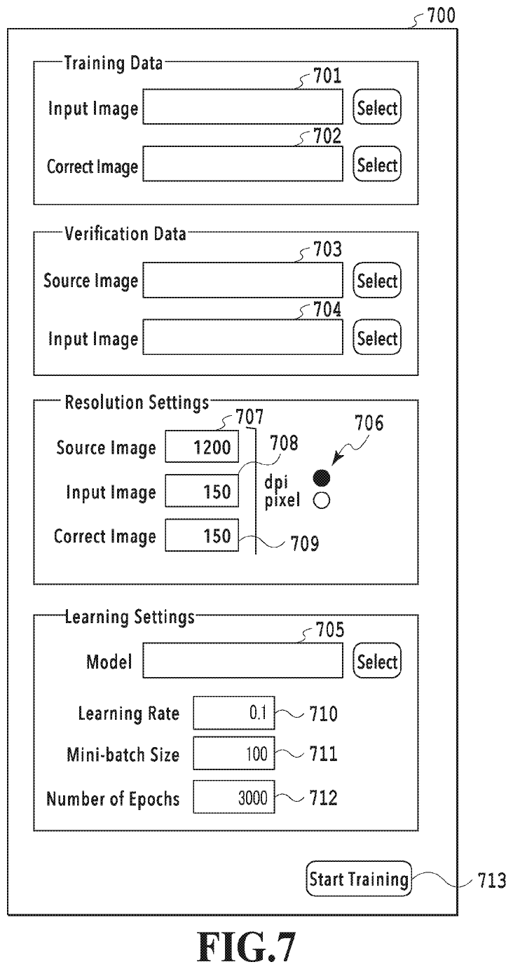

FIG. 7 is a diagram illustrating an example of a learning setting screen 700. The learning setting screen 700 is a setting screen for a learning process. This learning setting screen 700 is displayed by the learning apparatus 310.

For example, in response to receiving an instruction to launch an executable file, the learning apparatus 310 displays the learning setting screen 700, which is a user interface, on a display included in the learning apparatus 310. The executable file is stored in a storage device accessible by the learning apparatus 310. Note that the executable file is not limited to one which directly displays the learning setting screen 700 in response to being launched. For example, an executable file may be employed which displays a launcher screen in response to being launched, and displays the learning setting screen 700 in a case where an item for configuring learning settings provided in that launcher screen is selected.

The learning setting screen 700 is provided with a plurality of text boxes. In each text box, a folder path to a folder stored in a storage device accessible by the learning apparatus 310 is set.

A first text box 701 is a text box for setting a path to a folder storing source images for creating input images to be used for the learning. A second text box 702 is a text box for setting a path to a folder storing input images to be used for the learning. A third text box 703 is a text box for setting a path to a folder storing source images for creating training images to be used for accuracy verification in the learning. A fourth text box 704 is a text box for setting a path to a folder storing training images to be used for the accuracy verification in the learning. By using verification data besides training data, it is possible to obtain model parameters that do not overfit to the training data and have good generalization performance (learned parameter).

A fifth text box 705 is a text box for setting a path to a folder for a model structure to be used for the learning. A model structure indicates the structure of a machine learning model. That is, a model structure is information indicating a structure defining a machine learning model. For example, a model structure indicates the types, number, and the like of layers. The model structure is saved in a text format as structured data in the folder. In the folder, pieces of structured data corresponding to a plurality of machine learning models including the machine learning model 500 are saved.

The learning setting screen 700 is provided with select buttons respectively for the plurality of text boxes. In a case where the user presses a select button, a selection dialog corresponding to the pressed select button is displayed on the display. The user can select (designate) a folder in the selection dialogue and set the folder path to it in the text box.

The learning setting screen 700 is provided with a unit setting portion 706. The unit setting portion 706 is a setting portion where the unit of resolution is set. In the example of FIG. 7, “dpi” or “pixel” can be selected with a radio button. The user can set the unit of resolution by pressing the radio button for “dpi” or the radio button for “pixel.” In the example of FIG. 7, the radio button for “dpi” is turned on, and “dpi” is set as the unit of resolution.

The learning setting screen 700 is provided with a plurality of numerical value boxes. A numerical value is set in each numerical value box. A first numerical value box 707 is a box for setting the resolution of source images. This resolution of source images is set to a resolution which is higher than the resolution of the low-resolution color scan mode and at which the reading apparatus 100 is capable of performing reading. In the example of FIG. 7, 1200 dpi is set as the resolution of source images. A second numerical value box 708 is a box for setting the resolution of input images. The resolution of input images is set to a resolution which is equal to the resolution of the low-resolution color scan mode, at which the reading apparatus 100 is capable of performing reading. In the example of FIG. 7, 150 dpi is set as the resolution of input images. A third numerical value box 709 is a box for setting the resolution of correct images. In the example of FIG. 7, 150 dpi is set as the resolution of correct images.

A fourth numerical value box 710 is a box for setting the learning rate. The learning rate is a parameter that determines the degree to which the model parameters are updated during training of the machine learning model. The higher the learning rate, the higher the degree to which the model parameters are updated. A fifth numerical value box 711 is a box for setting the size of patches to be cut out of a source image. A sixth numerical value box 712 is a box for setting the number of epochs for the learning.

Also, the learning setting screen 700 is provided with a learning start button 713. The learning start button 713 is a button for starting the learning process. In response to a press on the learning start button 713, the learning apparatus 310 executes the learning process based on the contents of the settings set on the learning setting screen 700.

### <<Learning Process

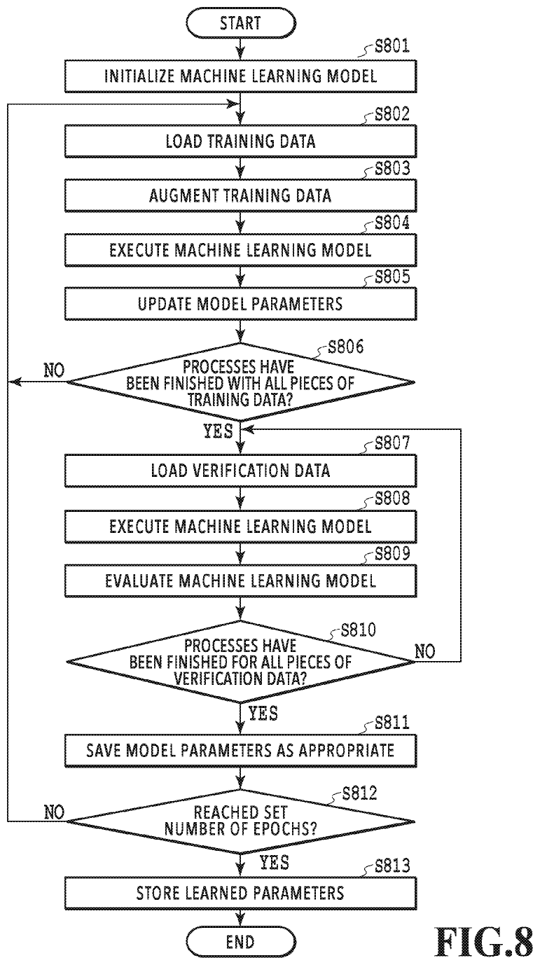

FIG. 8 is a flowchart illustrating an example of a learning process. The symbol “S” in the following description of the flowchart represents a step. The learning apparatus 310 implements the series of processes illustrated in the flowchart of FIG. 8 (learning process) by executing a program. The learning process starts in a case where the learning apparatus 310 accepts an instruction to start learning. The instruction to start learning is supplied to the learning apparatus 310 in response to a press on the learning start button 713.

In S801, the learning apparatus 310 initializes a machine learning model. Specifically, the learning apparatus 310 loads structured data from the folder path set in the fifth text box 705, and recognizes the machine learning model corresponding to that structured data as the machine learning model to be executed. Also, the learning apparatus 310 sets initial values of the model parameters to be used for the machine learning model to be executed. After the machine learning model is initialized, the process proceeds to S802.

Note that the initial values of the model parameters may be random values generated by a random number generator. Alternatively, the initial values of the model parameters may be values generated by an initialization algorithm, such as Xavier initialization or He initialization. Alternatively, the initial values of the model parameters may be values learned in advance using large datasets for other tasks such as image recognition.

In S802, the learning apparatus 310 loads a piece of training data. In the present embodiment, the training data includes a training pair being a pair of an input image loaded from the folder path set in the second text box 702 and a correct image representing a correct answer for that input image. After the training data is loaded, the process proceeds to S803.

Note that the input image is an image containing color shift. The input image is also called a sample image or a training image. The correct image is an image in which the color shift has been reduced. A plurality of training pairs are stored in a storage device accessible by the learning apparatus 310. The method of managing the training pairs is not particularly limited. For example, the images forming each training pair are managed are managed with the same file name. Alternatively, the images forming each training pair are managed with file names each having a prefix indicating an input image or a correct image. Alternatively, the images forming each training pair are recorded and managed in table data.

In S803, the learning apparatus 310 is performs augmentation of the training data loaded in S802. The augmentation of the training data is a process that generates various pieces of training data from one piece of training data by processing the piece of training data. After the augmentation of the training data is performed, the process proceeds to S804.

Note that examples of the processing of the training data include inversion, rotation, trimming, and the like. Also, the augmentation of the training data does not necessarily need to be performed during the learning process. The augmentation of the training data may be performed in advance before the learning process. In this case, the process of S803 is not executed.

In S804, the learning apparatus 310 causes the machine learning model corresponding to the structured data loaded in S801 to execute a process with the input image in the training data as an input, and obtains the result of that process as an output image. After the output image is obtained, the process proceeds to S805.

In S805, the learning apparatus 310 updates the model parameters. For example, the learning apparatus 310 updates the model parameters in such a way as to minimize the error between the output image obtained in S804 and the correct image paired with the input image input into the machine learning model in S804. In this case, the mean squared error, for example, is used as a function for calculating the error (loss function). Further, a gradient is calculated using error back propagation to update the model parameters. Note that the mean absolute error, perceptual similarity, or the like may be used as the loss function. After the model parameters are updated, the process proceeds to S806.

In S806, the learning apparatus 310 judges whether the processes of S802 to S805 (primary process) have been finished with all pieces of training data stored in the folders. The learning apparatus 310 returns to S802 if judging in S806 that the primary process has not been finished, and proceeds to S807 if judging that the primary process has been finished.

In S807, the learning apparatus 310 loads a piece of verification data. In the present embodiment, the verification data includes a verification pair being a pair of an input image loaded from the folder path set in the fourth text box 704 and a correct image representing a correct answer for that input image. After the verification data is loaded, the process proceeds to S808.

Note that a plurality of verification pairs are stored in a storage device accessible by the learning apparatus 310. The input image included in the verification data is different from the input image included in the training data. Similarly, the correct image included in the verification data is different from the correct image included in the training data. Using images that are not included in the training data for the verification data makes it possible to verify whether the machine learning model does not overfit to the training data and has appropriate generalization performance.

In S808, the learning apparatus 310 causes the machine learning model corresponding to the structured data loaded in S801 to execute a process with the input image in the verification data as an input, and obtains the output image output from the machine learning model as the result of that process. After the output image is obtained, the process proceeds to S809.

In S809, the learning apparatus 310 evaluates the accuracy of the machine learning model. For example, the learning apparatus 310 calculates an evaluation value using the output image obtained in S808 and the correct image paired with the input image input into the machine learning model in S808. In the present embodiment, the sum of the peak signal-to-noise ratio (PSNR) indicating the difference from the original pixels and the learned perceptual image patch similarity (LPIPS) indicating perceptual similarity between the images is calculated as the evaluation value. Note that an image quality evaluation index such as the structural similarity index measure (SSIM) may be calculated as the evaluation value. Alternatively, the value of the least square error between the estimated image and the correct image may be calculated as the evaluation value. After the accuracy of the machine learning model is evaluated, the process proceeds to S810.

In S810, the learning apparatus 310 judges whether the processes of S807 to S809 (secondary process) have been finished for all pieces of verification data stored in the folders. The learning apparatus 310 returns to S807 if judging in S810 that the secondary process has not been finished, and proceeds to S811 if judging that the secondary process has been finished.

In S811, the learning apparatus 310 saves the updated model parameters as appropriate. First, the learning apparatus 310 associates the current model parameters and the evaluation value calculated in S809 with each other. Then, if the evaluation value is higher than the highest evaluation value in the learning process, the learning apparatus 310 saves the model parameters and the evaluation value to a storage device and updates the highest evaluation value with the current evaluation value. Thereafter, the process proceeds to S812. Note that the initial value of the highest evaluation value is 0. Thus, the model parameters and the evaluation value are saved to the storage device without fail.

In S812, the learning apparatus 310 confirms whether the current number of repetitions of learning has reached the number of epochs set in the sixth numerical value box 712. The number of repetitions of learning is incremented in a case where it is confirmed that the secondary process has been finished, for example. If the current number of repetitions of learning has not reached the number of epochs, the learning apparatus 310 returns the process to S802, the process returns to S802. If the current number of repetitions of learning has reached the number of epochs, the learning apparatus 310 advances the process to S813.

In S813, the learning apparatus 310 controls the ROM 302, which is a storage unit of the reading apparatus 100, such that it stores the model parameters saved in the storage device as learned parameters. After the learned parameters are stored, the series of processes illustrated in the flowchart of FIG. 8, or the learning process, is terminated.

Note that, in the above learning process, the learned parameters are stored in a case where the number of repetitions of learning reaches the number of epochs, but the learning process is not limited to this. For example, in a case where the highest evaluation value does not get updated in S811 a certain number of times in a row, the learning apparatus 310 may consider that the optimization process has reached convergence, control the ROM 302 such that it stores the learned parameters, and then terminate the learning process.

### <<Training Data Creation Process>>

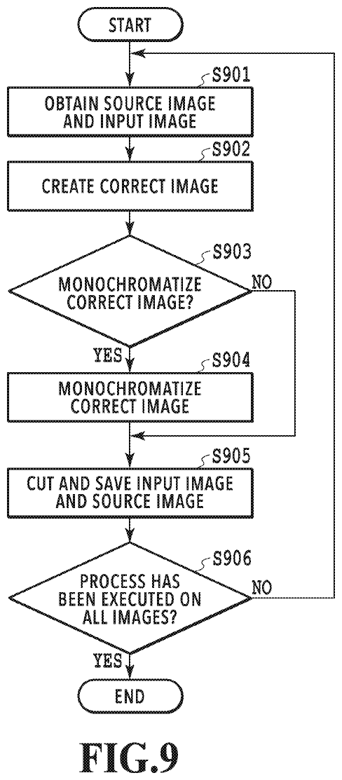

FIG. 9 is a flowchart illustrating an example of a training data creation process. The learning apparatus 310 executes the series of processes illustrated in the flowchart of FIG. 9 (training data creation process). For example, in response to a press on a button included in the learning apparatus 310, the learning apparatus 310 accepts an instruction to create training data and starts a training data creation process.

In S901, the learning apparatus 310 obtains a source image and an input image. Specifically, the learning apparatus 310 loads a source image from the folder with the folder path set in the first text box 701. Also, the learning apparatus 310 loads an input image from the folder with the folder path set in the second text box 702. After the source image and the input image are obtained, the process proceeds to S902.

In S902, the learning apparatus 310 obtains a correct image. Specifically, the learning apparatus 310 reduces the source image obtained in S901 to the resolution set in the third numerical value box 709. For example, a process of averaging each of the R, G, and B signal values of 8×8 pixels into the signal values of one pixel is performed. The image obtained as a result of the reduction is the correct image. This correct image has less color shift than that in the input image owing to the reduction. Note that, in a case where “pixel” is set on the unit setting portion 706, the learning apparatus 310 calculates correct image [pixel]/source image [pixel] to derive the reduction rate, and reduces the source image at the derived reduction rate. After the correct image is created, the process proceeds to S903.

In S903, the learning apparatus 310 judges whether to monochromatize the correct image created in S902. For example, in the folder with the folder path set in the first text box 701, a monochrome folder for storing document source images obtained by reading monochrome documents has been created. If the source image obtained in S901 is not from the monochrome folder, the learning apparatus 310 judges that the correct image created in S902 is to be monochromatized, and advances the process to S904. On the other hand, if the source image obtained in S901 is from the monochrome folder, the learning apparatus 310 judges that the correct image created in S902 is not to be monochromatized, and advances the process to S905.

In S904, the learning apparatus 310 monochromatizes the correct image created in S902. For example, a process of weighted-averaging the signal for each channel at a ratio of R:G:B=3:6:1 to derive a luminance value is performed. Performing the monochromatization may cause a shift in the luminance direction but can reduce the color shifts in the saturation direction and the hue direction to zero. After the monochromatization is performed, the process proceeds to S905.

In S905, the learning apparatus 310 cuts the input image obtained in S901 and the correct image obtained in S902 or S904, and saves the cut input image and correct image as a training pair to a storage location designated in advance. This storage location is a storage device accessible by the learning apparatus 310.

For example, a coordinate position (x,y)=(0-223,0-223) in an A4 150-dpi image (1240×1753 [pixels]) is cut out, and a file including the patch thus cut out and numerical values indicating its coordinate position (such as “_x0-223_y0-223”) is saved. Similarly, coordinate positions (x,y)=(0-223, 224-447) and (0-223, 448-671) are cut out and saved. In a case where the end in the y direction is reached, the position is set back to 0 in the y direction and shifted in the x direction, and patches are cut out and saved. Note that cutting may be performed with an overlap in a similar manner to the cutting process described in S905. This advantageously increases the amount of training data. The cutting size is 224×224 [pixels], for example.

In the present embodiment, both the source image and the input image are obtained without moving the document from the document plate 102. For this reason, positional alignment is omitted before the cutting. Alternatively, the cutting may be performed after positional alignment is performed. The positional alignment may be done by performing affine transformation or perspective transformation based on the coordinates of feature points, such as markers marked on the document or corners of objects within the images. Note that the transformation for the positional alignment causes blur in the images as it creates one pixel from a plurality of pixels. For this reason, the source image, which will be processed via reduction later, is transformed to implement positional alignment, and the input image is kept as is. By performing the transform for positional alignment on the source image in the 1200-dpi state, which is a state before reduction in S1202, and then performing the reduction, the blurring effect due to the transform for positional alignment can be less. After finishing the process of S905, the learning apparatus 310 advances the process to S906.

In S906, the learning apparatus 310 judges whether the process has been executed on all images stored in the folders. If the process has not been executed on all images stored in the folders, the learning apparatus 310 returns to S901. On the other hand, the process has been executed on all images stored in the folders, the learning apparatus 310 terminates the training data creation process.

The user can perform an operation to execute the training data creation process each time the user places a printed product on the document plate 102 from among a plurality of printed products. By doing so, a plurality of training pairs can be stored in the storage device. Note that verification data can be created by performing a creation process in a similar manner to that described above.

Note that the cutting of the input image and the correct image may be omitted. In this case, the input image obtained in S901 and the correct image obtained in S902 or S904 are saved as a training pair to a storage location designated in advance. Cutting the input image and the correct image as described above can reduce the processing load on the learning apparatus 310 as compared to not cutting the input image and the correct image. Also, in the present embodiment, both the source image and the input image are obtained by the same model as the reading apparatus 100, which performs a color shift correction process, but the present disclosure is not limited to this. The document may be read into the form of an image with a resolution exceeding the limit reading resolution of the reading apparatus 100 by a different reading apparatus and set as a source image. The different reading apparatus is, for example, an optical apparatus such as a scanner or a camera capable of performing high-resolution reading. In this case, the above-described positional alignment is performed on the source image. Also, a color conversion process is performed on the source image as necessary to adjust its colors to the reading apparatus 100. In this way, it is possible to obtain a source image with a resolution higher than the limit reading resolution of the reading apparatus 100, and perform color shift correction and super-resolution processing also in the reading mode with the highest resolution of the reading apparatus 100.

### <<Color Shift>>

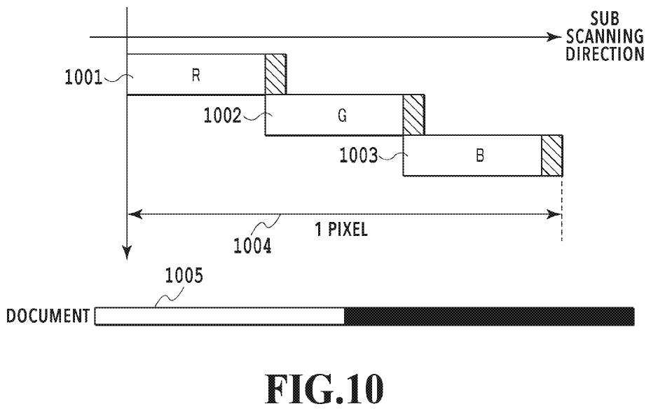

FIG. 10 is a schematic diagram of a case of reading one pixel at 150 dpi. In the example of FIG. 10, the vertical axis represents time while the horizontal axis represents the moving direction of the sensor 203. The moving direction of the sensor 203 is a direction that intersects (perpendicularly) the array direction of light receiving elements linearly arranged in the sensor 203, and is referred to as “sub scanning direction.”

Reference numeral 1001 in FIG. 10 denotes a range across which the sensor 203 receives light in a state where a red light source emits light. Reference numeral 1002 in FIG. 10 denotes a range across which the sensor 203 receives light in a state where a green light source emits light. Reference numeral 1003 in FIG. 10 denotes a range across which the sensor 203 receives light in a state where a blue light source emits light.

The hatched portion in each of the ranges 1001 to 1003 represents a reading width. The reading width means a length in the moving direction which the sensor 203 can read at once. In the example of FIG. 10, the hatched portion moves in the moving direction across a range 1004 equivalent to one pixel at 150 dpi to read each of the ranges 1001 to 1003.

Since the reading of the “R” part immediately follows the reading of “G” part, the ranges 1001 and 1002 overlap at the hatched portion, which substantially corresponds to the reading width of the sensor 203. Similar, since the reading of the “G” part immediately follows the reading of “B” part, the ranges 1002 and 1003 overlap at the hatched portion, which substantially corresponds to the reading width of the sensor 203.

A document 1005 that is present in the range 1004, which is equivalent to one pixel at 150 dpi, is white on the left side of the range 1004 and black on the right side of the range 1004. Across the range 1001, the sensor 203 receives light from a white portion of the document. Thus, the R signal value is a value of 65535, which is the maximum value with an unsigned 16-bit integer. Across the range 1002, the sensor 203 receives light from a white portion of the document in the first half and receives light from a black portion of the document in the second half. Thus, the G signal value is a value of 32767, which is the median of the range from 0 to 65535. Across the range 1003, the sensor 203 receives light from a black portion of the document. Thus, the B signal value is a value of 0. In sum, the value (R,G,B) of the pixel read across the range 1004 is (65,535,32767,0).

The range 1004 includes only white and black. For this reason, the value (R,G,B) of the pixel at the range 1004 should be (32767,32767,32767), which represents an achromatic color between white and black. However, as described above, the value (R,G,B) of the pixel read across the range 1004 is (65535,32767,0), which represents a chromatic color with high saturation. This is a color shift resulting from the shift in reading position between the light sources of the plurality of colors. This color shift tends to occur at portions with a large density difference, such as edges of objects.

The color shift does not occur only in a case where the document is black and white. For example, in a case where the right side of the document 1005 is green instead of black, the value (R,G,B) of the pixel at the range 1004 is ideally (32767,65535,32767). However, the value (R,G,B) of the pixel read across the range 1004 will be (65535,65535,0). Due to the color shift, the R signal value and the B signal value greatly differ from the ideal values.

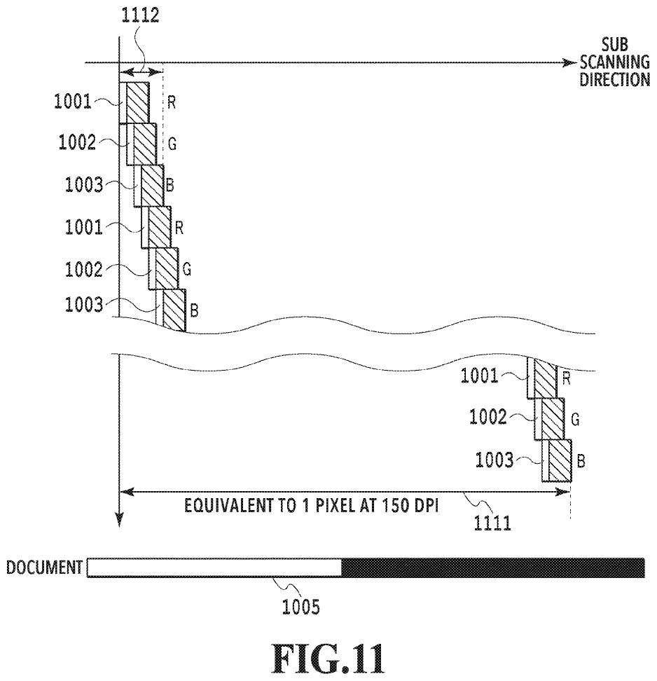

FIG. 11 is a schematic diagram of a case of reading one pixel at 1200 dpi. In the example of FIG. 11, a range 1111 equivalent to one pixel at 150 dpi is the same as the range 1004 in FIG. 10. In the range 1111, ranges 1001 to 1003 are each read eight times.

In a range 1112 equivalent to one pixel at 1200 dpi, the ranges 1001 and 1003 overlap. On the other hand, in the range 1004 in FIG. 10 equivalent to one pixel at 150 dpi, the ranges 1001 and 1003 do not overlap, and read separate positions on the document. This means that the lower the resolution, the higher the likelihood of a color shift, and the higher the resolution, the lower the likelihood of a color shift. Accordingly, by reducing the high-resolution (1200 dpi) source image obtained in S901 to a low resolution (150 dpi) in S902, an image (correct image) with a less color shift than that in the input image owing to the reduction is obtained. Note that the source image may be reduced to ½ or less. Also, reducing the high-resolution source image to a low resolution substantially prevents failure to detect an object such as a fine line or a dot present between the R, G, and B channels. That is, the reduction can prevent or reduce the occurrence of problems such as the presence of unread spaces.

In a case of performing a process of averaging each of the R, G, and B signal values of 8×8 pixels into the signal values of one pixel as the reduction of the source image in S902, it means that eight pixels are averaged in the moving direction of the sensor 203. This is equivalent to performing sampling eight times. Further, even in a case where a color shift has occurred in some of the eight pixels, the averaging with the pixels without a color shift can reduce the color shift.

Note that the resolution of the source image has been described as 1200 dpi, which is 8 times 150 dpi, as an example, but is not limited to this. The higher the resolution of the source image, the better up to a certain scale factor. However, even 2 times 150 dpi, for example, can still reduce a color shift to about ½.

The resolution of the source image may be set according to the reading width of the sensor 203. Specifically, the resolution of the source image in a case where the sensor 203 has a first reading width is lower than the resolution of the source image in a case where the second 203 has a second reading width smaller than the first reading width. For example, the resolution of the source image in a case where the first reading width is 21 μm is smaller than the resolution of the source image in a case where the second reading width is 10.5 μm.

The resolution of the source image may be more than or equal to two times the resolution of the input image. Also, the resolution of the source image may be a resolution that satisfies the following condition. This condition is that, in a range equivalent to one pixel, a range to be read by the sensor 203 in a case where the first light source in the order of light emission emits light is included and is adjacent to or partly overlaps the range to be read by the sensor 203 in a case where that light source emits light next. In the example of FIG. 11, the range 1112 equivalent to one pixel at the resolution of the source image includes a range 1001 to be read in a case where the R light source emits light for the first time, and part of a range 1001 to be read in a case where the R light source emits light for the second time. This makes it possible to read a fine line or a dot without failing to detect it across two pixels in the source image.

Note that, in S902, a process other than the process of averaging each of the R, G, and B signal values of 8×8 pixels into the signal values of one pixel may be used for the reduction of the source image. Examples include a bilinear reduction process. In the bilinear reduction process, reduction using only four pixels may be performed. In this case, simply performing reduction into 1/(8×8) in terms of area may use only 4 pixels among 16 pixels. Thus, reduction into 1/(2×2) is performed three times to use substantially all of the 8×8 pixels. This enhances the effect of the color shift reduction by averaging. The reason for performing reduction into 1/(2×2) three times is that 8 is the cube of 2.

In the above description, the source image is divisible by the input image, but does not need to be divisible by the input image. In a case where the source image is not divisible by the input image, weighted averaging may be performed taking into account how much each pixel in the source image contributes in terms of area to a desired pixel position, for example. In that case, a bilinear reduction process is effective. Also, the bilinear reduction process is employable even in a case where the aspect ratio of the read document is not even, such as in a case where the width-to-height rate is 1:2. Here, obtaining pixel values in a mode in which the number of pixels is larger in the sub scanning direction is more efficient.

In the present embodiment, the model parameters of the machine learning model are learned using patches from an input image read at a first resolution and a correct image obtained by reducing an image read at a resolution higher than the first resolution. The model parameters thus learned, or the learned parameters, are stored in the ROM 302, which is a storage device.

### <Color Shift Correction Process>

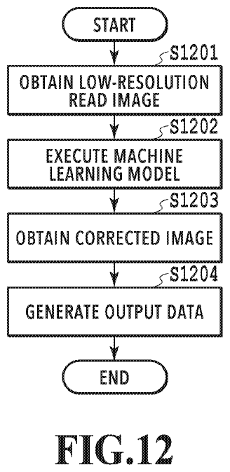

FIG. 12 is a flowchart illustrating an example of a process in the present embodiment performed by the reading apparatus 100. The series of processes illustrated in the flowchart of FIG. 12 is a color shift correction process. Also, the color shift correction process is implemented by the CPU 301 loading a program stored in the ROM 302 or the like to the RAM 303 and executing it. The color shift correction process starts in response to a press on the button for executing the low-resolution color scan mode (second read button). Note that the color shift correction process does not start in response to a press on the button for executing the high-resolution color scan mode (first read button). Also, the color shift correction process does not start in response to a press on the button for executing the high-resolution monochrome scan mode (third read button). This is because a color shift tends not to occur with an image read at high resolution. Note that, depending on the value of the high resolution, the color shift correction process may start in response to a press on the first read button or the third read button.

In S1201, the CPU 301 obtains a read image of a document placed on the document plate 102. Specifically, the CPU 301 controls the drive unit 307 to cause the reading unit 103 to read the document placed on the document plate 102. Then, the CPU 301 controls the scanning unit 305 to generate image data corresponding to the low-resolution color scan mode based on a signal output from the reading unit 103. Then, the CPU 301 controls the image processing unit 304 to cause the image processing unit 304 to execute the image processing illustrated in FIG. 4. The image data subjected to this image processing is the read image of the document. The resolution of the read image is a low resolution, and color shift may appear in the read image. After the read image of the document is obtained, the process proceeds to S1202.

In S1202, the CPU 301 causes a machine learning model to execute a process. Specifically, the CPU 301 transmits the learned parameters stored in the ROM 302 and the read image obtained in S1201 to the image processing unit 304 along with a model execution request. Thereafter, the process proceeds to S1203.

The model execution request is a request to cause the machine learning model to execute a process with the read image as an input by using the learned parameters. In response to accepting this model execution request, the image processing unit 304 causes the machine learning model to execute a process with the read image as an input by using the learned parameters. The machine learning model outputs an image as the result of this process, and the image processing unit 304 transmits that image as a response to the model execution request to the CPU 301.

In S1203, the CPU 301 obtains a corrected image. Specifically, the CPU 301 obtains the image transmitted as a response to the model execution request from the image processing unit 304. In this image, the color shift has been reduced. That is, the process by the machine learning model using the learned parameters was a correction process for reducing the color shift. The CPU 301 obtains the image transmitted as the result of the process by the machine learning model from the learning apparatus 310 as a corrected image. After receiving the image transmitted from the learning apparatus 310, the CPU 301 advances the process to S1204.

In S1204, the CPU 301 generates output data. For example, the CPU 301 converts the file format of the image obtained in S1203. The file format may be a preset format or designated based on the user's operation on the operation part 104. Examples of the file format file include bitmap, Joint Photographic Experts Group (JPEG), Portable Network Graphics (PNG), and the like. After the output data being the data of the image subjected to the file format conversion is obtained, the series of processes illustrated in the flowchart of FIG. 12, or the color shift correction process, is terminated.

As described above, according to the present embodiment, it is possible to effectively reduce a color shift. For example, the CPU 301 as a reading control unit controls the reading apparatus 100 to read a document. The CPU 301 as a model execution unit causes a machine learning model to execute a process with the read image of the document as an input by using learned parameters. The CPU 301 as an obtaining unit obtains an image output from the machine learning model as a result of executing the process with the read image as an input, the obtained image being an image representing the read image with a reduced color shift.

The learned parameters used by the CPU 301 as the model execution unit are model parameters learned using input images and correct images. The input images are images having a color shift resulting from the shift in reading position between light sources of a plurality of colors. The correct images are images that correspond to the respective input images and are obtained by reducing a source image having a higher resolution than that of the input image. A color shift tends not to occur in high-resolution images. For this reason, in the correct images, a color shift that may result from reading by the reading apparatus 100 is reduced. By using parameters learned using such correct images, an image output from a machine learning model with a read image of a document as an input can be obtained as an image in which a color shift has been effectively reduced.

The resolution of the source image is set according to the reading width of the sensor 203 included in the reading apparatus 100. This resolution of the source image is more than or equal to two times the resolution of the input image. Alternatively, the resolution of the source image is such a resolution that, in a range equivalent to one pixel, a range to be read by the sensor 203 in a case where the first light source in the order of light emission emits light is included and is adjacent to or partly overlaps the range to be read by the sensor 203 in a case where that light source emits light next. In this way, it is possible obtain an image in which a color shift has been effectively reduced without failing to detect an object such as a fine line or a dot present between the light sources.

Also, in the present embodiment, the reading apparatus 100 is capable of switching between a first scan mode in which the reading apparatus 100 performs reading at a first resolution and a second scan mode in which the reading apparatus 100 performs reading at a second resolution higher than the first resolution. In the low-resolution color scan mode, which is the first scan mode, the CPU 301 as the model execution unit causes a machine learning model to execute a process. On the other hand, in the high-resolution color scan mode or the high-resolution monochrome scan mode, which is the second scan mode, the CPU 301 as the model execution unit does not cause a machine learning model to execute the process. In this way, it is possible to effectively reduce a color shift while reducing the processing load on the reading apparatus 100.

### Second Embodiment

### Overview

In the present embodiment, an example in which super-resolution processing is performed simultaneously with color shift correction will be described. Note that, in the following, description of contents common to the first embodiment will be omitted as appropriate, and the difference will be mainly described.

### <Machine Learning>

In the present embodiment, an image generation model that outputs a super-resolution image is used as a machine learning model. Specifically, in the first embodiment, output data from the machine learning model is 224×224 [pixels] RGB image data but, in the present embodiment, output data from the machine learning model is 448×448 [pixels] RGB image data.

### <<Machine Learning Model>>

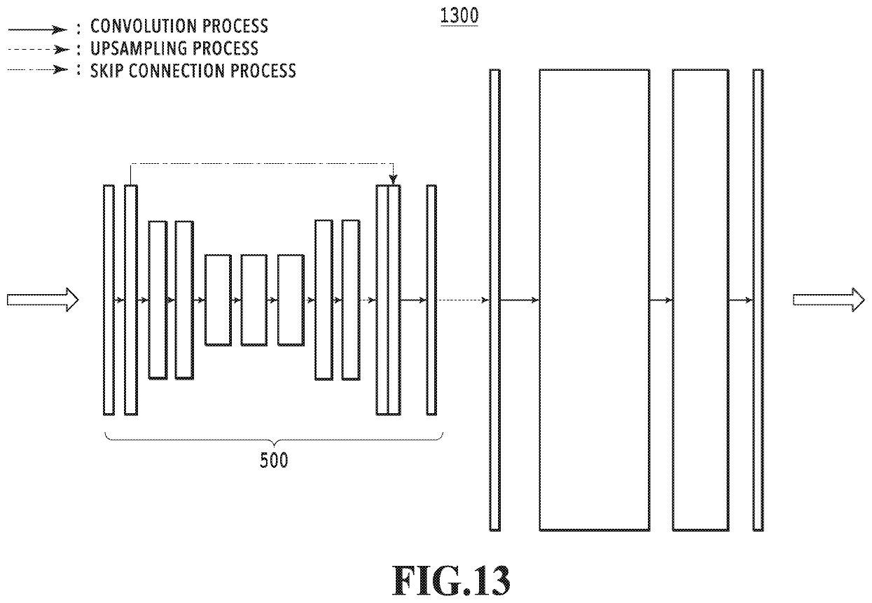

FIG. 13 is a schematic diagram of a CNN model used in the present embodiment. A machine learning model 1300 represents the structure of a CNN model. In the example of FIG. 13, each rectangle represents data, and each solid arrow represents a convolution process, as in the example of FIG. 5.

The machine learning model 1300 involves four additional processes following the output of the machine learning model 500. Specifically, the image data obtained by the eighth convolution process is subjected to an upsampling process. This upsampling process increases the number of pixels by four times (two times in both the vertical direction of the horizontal direction of the image). Then, the image data obtained by the upsampling process is subjected to a ninth convolution process. The ninth convolution process uses, for example, 64 filters. Then, the image data obtained by the 9th convolution process is subjected to a 10th convolution process. The 10th convolution process uses, for example, 32 filters. Then, the image data obtained by the 10th convolution process is subjected to an 11th convolution process. The 11th convolution process uses, for example, three filters, which is the same number as the number of output channels. This image data obtained by the 11th convolution process is output as the result of the processing by the machine learning model 1300.

As described above, the structure of the machine learning model 1300 has 11 convolution process layers, three upsamplings, and one skip connection, but is not limited to this. The machine learning model 1300 may employ a different structure that outputs an image with a resolution that is N times the resolution of an input image in both the vertical direction and the horizontal direction.

### <<Training Data Creation Process>>

In the first embodiment, in S902, a process of averaging each of the R, G, and B signal values of 8×8 pixels into the signal values of one pixel is performed to create a 150-dpi correct image. In the present embodiment, a process of averaging each of the R, G, and B signal values of 4×4 pixels into the signal values of one pixel is performed to create a 300-dpi correct image. Specifically, in the present embodiment, the resolution in the third numerical value box 709 is set to 300 dpi.

Note that the resolution of the source image is 1200 dpi, as in the first embodiment, but is not limited to this. For example, the resolution of the source image may be 2400 dpi. In this way, the degree of reduction of the color shift in the correct image can be higher than that in the case where the resolution of the source image is 1200 dpi. Note that, as long as the resolution of the source image is higher than the resolution of the input image, the color shift is reduced in the correct image.

As described above, according to the present embodiment, the machine learning model 1300 is a model that outputs an image with a large image size than the input image. Thus, by simply inputting a read image of a document into the machine learning model, the reading apparatus 100 can obtain an image in which the color shift has been reduced as compared to the read image and which has a higher resolution than the read image. In other words, the time it takes for the machine learning model to execute a process covers the processing time for color shift correction and the processing time for super-resolution processing. Also, in the present embodiment, the super-resolution processing brings about an effect of reproducing fine lines and dots more clearly. Accordingly, an image with good quality can be obtained.

### Third Embodiment

### Overview

In the present embodiment, an example in which correct images are created with a simulator will be described. Note that, in the following, description of contents common to the first embodiment will be omitted as appropriate, and the difference will be mainly described.

### <<Learning Setting Screen>>

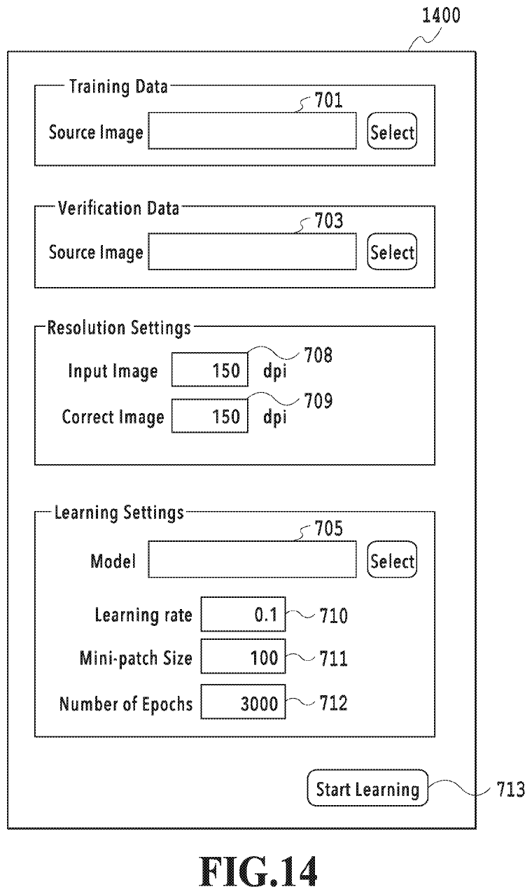

FIG. 14 is a diagram illustrating an example of a learning setting screen 1400 in the present embodiment. This learning setting screen 1400 is displayed on the display included in the learning apparatus 310, like the learning setting screen 700 in FIG. 7. The learning setting screen 1400 is simpler than the learning setting screen 700 in FIG. 7. Specifically, the learning setting screen 1400 does not include the second text box 702 or the fourth text box 704. This is because a simulator creates input images. Moreover, the learning setting screen 1400 does not include the unit setting portion 706 or the first numerical value box 707. This is because the simulator creates correct images being images with a resolution which is higher than the resolution of the low-resolution color scan mode and at which the reading apparatus 100 is capable of performing reading. In the present embodiment, the unit of resolution s “dpi” but may be “pixel” instead.

### <<Training Data Creation Process>>

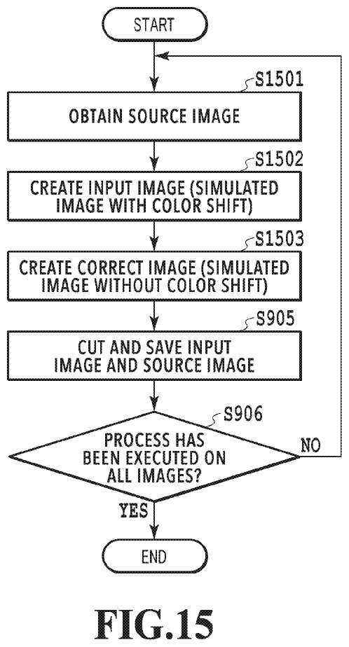

FIG. 15 is a flowchart illustrating an example of a training data creation process in the present embodiment. The learning apparatus 310 executes the series of processes illustrated in the flowchart of FIG. 15 (training data creation process). For example, in response to a press on a button included in the learning apparatus 310, the learning apparatus 310 accepts an instruction to create training data and starts a training data creation process. In the training data creation process in the present embodiment, the processes of S901 to S904 illustrated in the flowchart of FIG. 9 in the first embodiment are replaced with the processes of S1501 to S1503.

In S1501, the learning apparatus 310 obtains a source image. Specifically, the learning apparatus 310 loads a source image from the folder with the folder path set in the first text box 701. In the present embodiment, the color of each pixel of the source image is represented using R, G, and B components, and the source image is obtained in a data format in which each component is expressed on a 16-bit scale. After the source image is obtained, the process proceeds to S1502.

In S1502, the learning apparatus 310 creates an input image with a simulator. In the present embodiment, the input image is created at 150 dpi. Note that the input image contains a color shift, as in the first embodiment. Details of the creation of the input image by the simulator will be described later. After the input image is created by the simulator, the process proceeds to S1503.

In S1503, the learning apparatus 310 creates a correct image with the simulator. In the present embodiment, the correct image is created at 150 dpi. Note that the color shift has been reduced in the correct image, as in the first embodiment. Details of the creation of the correct image by the simulator will be described later. After the correct image is created by the simulator, the process proceeds to S905.

### <<Simulator>>

The simulator is an application that operates on the learning apparatus 310. The simulator has been subjected to an adjustment process in advance using a chart image. The chart image is an image obtained by reading a chart in which white and black patches are printed with the reading apparatus 100.

In the adjustment process, the simulator sets a plurality of patches in a chart image and derives the density distribution of each patch. It is possible that a color shift occurs at the edges of the patches. For this reason, the density distribution of each patch is derived using the pixel values of a portion of the patch present around its center and excluding its edges.

Specifically, the simulator derives the largest value and the smallest value of each of the R, G, and B channels for the pixels in each patch. For example, a largest value Rxmax of the R channel at a pixel and a smallest value Rxmin of the R channel at a pixel are derived by the following equations.

$$Rx max = ( R w max \times ( R x - R b ) + R b max \times ( R w - R x ) ) / ( R w - Rb )$$

$$Rx min = ( Rw min \times ( R x - R b ) + R b min \times ( R w - R x ) ) / ( R w - R b )$$

Rx in the above equations denotes the RAW value of the R channel. Rw in the above equations denotes an average value of the white patch. Rwmax in the above equation denotes the largest value in the white patch. Rwmin in the above equation denotes the smallest value in the white patch. Rb in the above equations denotes an average value of the black patch. Rbmax in the above equation denotes the largest value in the black patch. Rbmin in the above equation denotes the smallest value in the black patch.

In the above equations, the largest value Rxmax and the smallest value Rxmin are derived based on the ratio between a first distance and a second distance. The first distance is the distance between the average value Rw of the white patch and the RAW value Rx. The second distance is the distance between the average value Rb of the black patch and the RAW value Rx. Note that, in a case where the RAW value Rx is less than the average value Rb of the black patch, the calculation is performed with the RAW value Rx clipped to the average value Rb of the black patch. Also, in a case where the RAW value Rx is more than the average value Rw of the white patch, the calculation is performed with the RAW value Rx clipped to the average value Rw of the white patch.

By deriving the largest value and the smallest value of each of the R, G, and B channels for the pixels in each patch, it is possible to figure out how much noise is added to the luminance values of the chart image. The noise includes a noise originating from the sensor 203 and a noise originating from the printing.

Next, the creation of the input image by the simulator will be described. In the present embodiment, the resolution of the source image obtained in S1501 is 4800 dpi. Also, the resolution of the input image created in S1502 is 150 dpi.

In simulator, the reading width of the sensor 203 is set. In the present embodiment, the reading width of the sensor 203 is set at 21 [μm]. The closer the reading width of the sensor 203 is to the actual value, the higher the accuracy of the simulation.

A length in the moving direction of the sensor 203 equivalent to one pixel at 150 dpi is approximately 169.33 [μm]. As illustrated in FIG. 10, the range 1001 to be read by the sensor 203 for the R light source, the range 1002 to be read by the sensor 203 for the G light source, and the range 1003 to be read by the sensor 203 for the B light source are approximately 70.44 [μm]. Each of the ranges 1001, 1002, and 1003 is equivalent to 13.31 pixels at 4800 dpi. This is because an edge of one pixel at 4800 dpi is approximately 5.29 [μm], and 70.44/5.29≈13.31. Thus, the reading of each of the R, G, and B channels is performed at intervals of 13.31 [pixels].

Here, the ranges 1001 and 1002 overlaps by the reading width of the sensor 203, which is 21 [μm]. similarly, the ranges 1002 and 1003 overlap by the reading width of the sensor 203, which is 21 [μm]. For this reason, the head position of the reading of the next channel is approximately after 9.34 [pixels].

The method of deriving 9.34 [pixels] is as follows. Specifically, the reading width of the sensor 203 21 [μm], and an edge of one pixel at 4800 dpi is approximately 5.29 [μm]. Hence, the number of pixels within the reading width of the sensor 203 is 21/5.29~3.97 [pixels]. The number of pixels within the reading width of the sensor 203, or 3.97 [pixels], is subtracted from 13.31 pixels, which is equivalent to each of the above-described ranges 1001, 1002, and 1003. As a result, the head position of the reading of the next channel is approximately after 9.34 [pixels].

The simulator derives the head position of the reading of the next channel based on the reading width of the sensor 203 and the resolution of the source image. In S1502, based on the head position of the reading of the next channel, the pixel values of a 150-dpi image are read in the moving direction of the sensor 203 (sub scanning direction) from the 4800-dpi source image obtained in S1501. Table 1 below illustrates an example of specific reading coordinates.

TABLE 1

| Coordinates in Output (150 dpi) Image | | Coordinates in 4800-dpi Image | | |
|---|---|---|---|---|
| x | y | | x | y |
| 0 | 0 | R | 0.00-32.00 | 0.00-13.31 |
| | | G | 0.00-32.00 | 9.34-22.66 |
| | | B | 0.00-32.00 | 18.69-32.00 |
| 0 | 1 | R | 0.00-32.00 | 28.03-41.34 |
| | | G | 0.00-32.00 | 37.38-50.69 |
| | | B | 0.00-32.00 | 46.72-60.03 |
| 0 | 2 | R | 0.00-32.00 | 56.06-69.38 |
| | | G | 0.00-32.00 | 65.41-78.72 |
| | | B | 0.00-32.00 | 74.75-88.06 |
| . . . | . . . | . . . | . . . | . . . |

The pixel value of the output 150-dpi image at each set of coordinates in Table 1 above is derived by averaging the pixels indicated by sets of coordinates in the 4800-dpi image into one pixel. For example, the pixel value of the R channel of the pixel at (x,y)=(0,0) in the 150-dpi image is derived by averaging the pixel values of the R channels of the pixels at (x,y)=(0.00-32.00,0.00-13.31) in the 4800-dpi image. The pixel value of the G channel of the pixel at (x,y)=(0,0) in the 150-dpi image is derived by averaging the pixel values of the G channels of the pixels at (x,y)=(0.00-32.00,9.34-22.66) in the 4800-dpi image. The pixel value of the B channel of the pixel at (x,y)=(0,0) in the 150-dpi image is derived by averaging only the pixel values of the B channels of the pixels at (x,y)=(0.00-32.00,18.69-32.0) in the 4800-dpi image. The R, G, and B values thus derived are set as one pixel at 150 dpi.

Now, the pixel ranges in Table 1 above will be described. The “sets of coordinates in the 4800-dpi image” indicate the positions of sets of coordinates. For example, (x)=(0.00-32.00) indicates the position of the head (0.00) of the pixel at x=0 up to the end of the pixel at x=31. Also, for a pixel position at the decimal level, a weight is applied according to its range, and an average value is derived by weighted averaging. Specifically, the calculation is performed with the value after the decimal point as a weight. For example, for (y)=(0.00-13.31), the calculation is performed with 1.0 as the weight for the pixels with y=0 to 12 and with the value after the decimal point, or 0.31, as the weight for the pixel with y=13. A weight is individually derived for both x and y, and a value obtained by multiplying those is set as the weight for the weighted averaging.

Because the pixels averaged to make a single image, the image is in a reduced state. Also, the act of averaging the pixel values is part of the simulation, and is equivalent to sampling the document.

Reading the pixel value at each set of coordinates in a 150-dpi image from the 4800-dpi source image adds the above-mentioned noise to the 150-dpi image. Specifically, using the above-described equations with the value of each of the R, G, and B channels of each pixel in the 150-dpi image as the RAW value Rx, the largest value Rxmax and the smallest value Rxmin, which are pixel values (luminance values) to which the noise is added, are calculated. A value within the range from the smallest value to the largest value is derived at random as a random number, and this random value is set as the pixel value in the 150-dpi image. A pixel value to which the noise is added is stored in a memory for each set of coordinates for each channel. The pixel value to which the noise is added is a value obtained by subtracting the RAW value Rx from the above-described random value.

Note that the method of deriving the noise-containing value of each channel is not limited to the above method, and the noise may be derived by a different method. For example, a chart with patches in 16 shades of gray from white to black is read at 150 dpi and an average value, the largest value, and the smallest value of each of the R, G, and B channels are derived for the pixels in each patch and recorded. Based on the recorded values, a lookup table (LUT) that outputs a largest value and a smallest value in response to input of luminance is created using the average value as luminance for each of R, G, and B. By using these LUTs, the largest value and the smallest value of each channel containing noise in luminance can be derived more specifically.

Each channel containing noise may be derived using a three-dimensional LUT. For example, a color chart with 729 patches formed by nine grids for each of R, G, and B is read at 150 dpi, and an average value, the largest value, and the smallest value of each of the R, G, and B channels are derived for the pixels in each patch and recorded. Based on the recorded values, a three-dimensional LUT that outputs a largest value and a smallest value in response to input of an average RGB value is created for each of R, G, and B. By using these LUTs, the largest value and the smallest value of each channel containing noise in an RGB space can be derived more specifically. Note that, in a case where the RGB value input into the LUT is not present within the recorded RGB range, the value at the closest point may be calculated and the LUT may be searched using that value.

The 150-dpi image (input image) thus created is an image obtained by simulating document reading, and a color shift is present therein.

Next, the creation of the correct image by the simulator will be described. In the present embodiment, the resolution of the correct image created in S1503 is 150 dpi. In S1503, the pixel values of a 150-dpi image are read in the moving direction of the sensor 203 (sub scanning direction) from the 4800-dpi source image obtained in S1501, as with the input image. Note that the same range is read for all of the R, G, and B channels, so that no positional shift or no reading failure occurs. Specifically, the entire range 1004 illustrated in FIG. 10 is read for all of the R, G, and B channels. Table 2 below illustrates an example of specific reading coordinates.

TABLE 2

| Coordinates in Output (150 dpi) Image | | Coordinates in 4800-dpi Image | | |
|---|---|---|---|---|
| x | y | | x | y |
| 0 | 0 | R | 0.00-32.00 | 0.00-32.00 |
| | | G | 0.00-32.00 | 0.00-32.00 |
| | | B | 0.00-32.00 | 0.00-32.00 |
| 0 | 1 | R | 0.00-32.00 | 28.03-60.03 |
| | | G | 0.00-32.00 | 28.03-60.03 |
| | | B | 0.00-32.00 | 28.03-60.03 |
| 0 | 2 | R | 0.00-32.00 | 56.06-88.06 |
| | | G | 0.00-32.00 | 56.06-88.06 |
| | | B | 0.00-32.00 | 56.06-88.06 |
| . . . | . . . | . . . | . . . | . . . |

The pixel value of the output 150-dpi image at each set of coordinates in Table 2 above is derived by averaging the pixels indicated by the corresponding set of coordinates in the 4800-dpi image into one pixel. Reading the pixel value at each set of coordinates in a 150-dpi image from the 4800-dpi source image adds the above-mentioned noise to the 150-dpi image. The noise value at the same set of coordinates as that stored in the memory in the creation of the input image is added for each channel, and the resulting value is set as a pixel value. Note that this addition of the noise does not necessarily need to be performed. In this way, the machine learning model performs a correction that reduces the noise.

Each pixel in the input image created by the simulator in S1502 and that in the correct image created by the simulator in S1503 are read from the source image obtained in S1501 across the same range. Also, there is no region left unread between the R, G, and B channels, preventing failure to detect an object such as a fine line or a dot present between the channels.

As described above, according to the present embodiment, an input image and a correct image are created by a simulator. For example, the simulator creates an input image and a correct image by reading pixels equivalent to the reading resolution of the reading apparatus 100 from a source image. In this way, it is possible to easily create a large number of images required for machine learning.

Note that, in the present embodiment, a random digital image may be used as a source image. For example, a source image may be obtained by a program that depicts, in a background image with a color having random R, G, and B values, rectangles, lines, circles, or the like having other random R, G, and B values at random coordinates. In this way too, it is possible to easily create a large number of images required for machine learning. Also, the machine learning model may be a model initially trained using data including image data created by the simulator and subsequently trained using data including high-resolution images with a higher resolution than the resolution of images to be input or image data obtained by reducing the high-resolution images.

### Fourth Embodiment

### Overview

In the present embodiment, an example in which learned parameters learned using input images and correct images created by the simulator in the third embodiment are re-learned will be described. Note that, in the following, description of contents common to the first embodiment will be omitted as appropriate, and the difference will be mainly described.

### <<Re-Learning Setting Screen>>

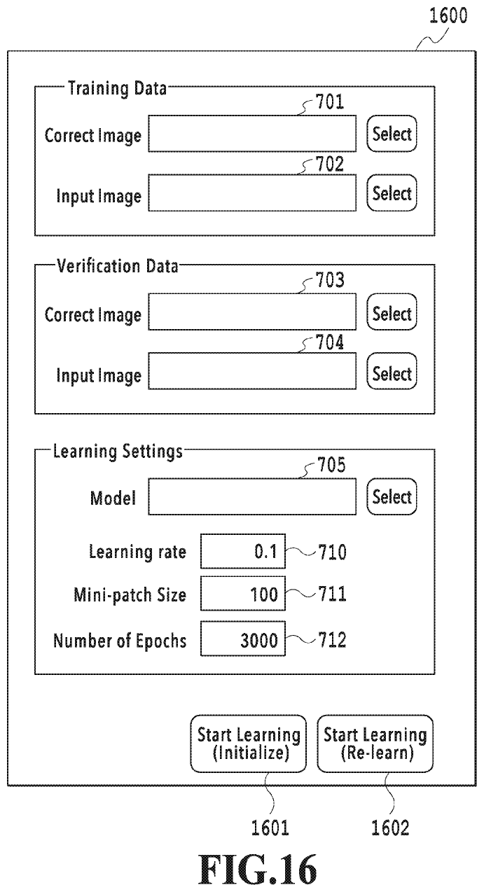

FIG. 16 is a diagram illustrating an example of a re-learning setting screen 1600 in the present embodiment. The re-learning setting screen 1600 is displayed on the display included in the learning apparatus 310, like the learning setting screen 700 in FIG. 7. The re-learning setting screen 1600 is simpler than the learning setting screen 700 in FIG. 7. Specifically, the re-learning setting screen 1600 includes no resolution settings. More specifically, the re-learning setting screen 1600 includes none of: the unit setting portion 706 for setting the unit of resolution; the first numerical value box 707 for setting the resolution of source images; the second numerical value box 708 for setting the resolution of input images; or the third numerical value box 709 for setting the resolution of correct images. This is because the resolutions have already been set to obtain learned parameters before the re-learning stage.

The re-learning setting screen 1600 is provided with a first learning start button 1601 and a second learning start button 1602 in place of the learning start button 713 in FIG. 7. The first learning start button 1601 is a button for initializing the learned parameters and starting learning anew. The second learning start button 1602 is a button for updating the learned parameters via re-learning.

In a case of accepting an instruction to perform re-learning in response to a press on the second learning start button 1602, the learning apparatus 310 obtains the learned parameters from the reading apparatus 100 and updates the obtained learned parameters based on the contents set on the re-learning setting screen 1600. For example, based on the contents set on the re-learning setting screen 1600, the learning apparatus 310 executes the learning process illustrated in the flowchart of FIG. 8 and updates the learned parameters obtained from the reading apparatus 100. After updating the learned parameters, the learning apparatus 310 requests the reading apparatus 100 to store the updated learned parameters to rewrite the learned parameters stored in the reading apparatus 100 to the updated learned parameters.

According to the present embodiment, a machine learning model that has learned rules for correcting a color shift via simulation is subjected to re-learning using training data created from data obtained by actual reading. In this way, it is possible to perform a color shift correction taking actual device characteristics of the reading apparatus 100 into account. Note that the re-learning may be performed using the machine learning model 1300.

### OTHER EMBODIMENTS

In the above-described embodiments, the reading apparatus 100 is a single-function scanner including only the scanning unit 305, but the present disclosure is not limited to this. For example, the reading apparatus 100 may be a copying apparatus including the scanning unit 305 and a unit other than the scanning unit 305. The copying apparatus is also called a multifunction peripheral (MFP).

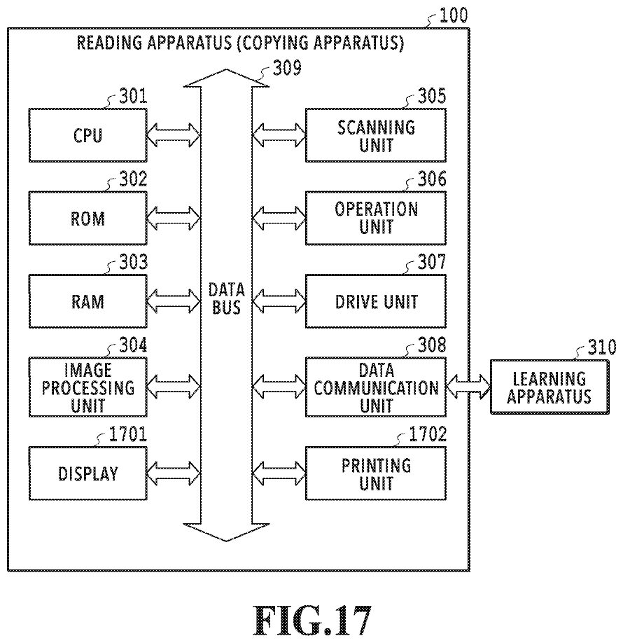

FIG. 17 is a block diagram illustrating an example of a configuration of the reading apparatus 100 in a case where it is a copying apparatus. The copying apparatus further includes a touch display 1701 and a printing unit 1702 in addition to the configuration of the reading apparatus 100 described above. The touch display 1701 has a liquid crystal layer and a touch sensor layer. The touch display 1701 is capable of displaying images such as read images, user interface screens, and the like. Also, the touch display 1701 is capable of accepting various pieces of information in response to the user's operations on the user interface screens. The printing unit 1702 is a unit capable of printing images and the like.

Including the touch display 1701 makes it possible to execute a scan mode with software keys on a user interface screen without a button included in the operation part 104 (hardware key). Note that the touch display 1701 may be included in the reading apparatus 100 in the above-described embodiments (single-function scanner).

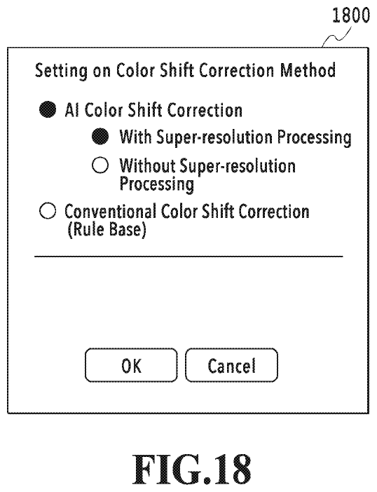

Also, in the above-described embodiments, the reading apparatus 100 does not switch between a color shift correction process using a machine learning model and a color shift correction process using a rule base, but the present disclosure is not limited to this. For example, the reading apparatus 100 may be capable of switching between a color shift correction process using a machine learning model and a color shift correction process using a rule base according to the user's operation. An example in which the reading apparatus 100 is capable of switching between a color shift correction process using a machine learning model and a color shift correction process using a rule base according to the user's operation will be described below using FIG. 18.

FIG. 18 is a diagram illustrating an example of a UI screen 1800 for correction modes. The UI screen 1800 is displayed on a display of an information terminal connected to the reading apparatus 100 through the data communication unit 308, for example. The information terminal may be a personal computer, a smartphone, or the like. In a case where the reading apparatus 100 includes the touch display 1701, the UI screen 1800 may be displayed on the touch display 1701.

Also, the UI screen 1800 is displayed by the CPU 301. The CPU 301 displays the UI screen 1800, for example, in a case where “Color shift Correction Method” is selected from among setting items in a top screen (not illustrated) displayed on the touch display 1701 or the like.

On the UI screen 1800, “AI Color Shift Correction with Super-resolution Processing” as a first correction mode, “AI Color Shift Correction without Super-resolution Processing” as a second correction mode, or “Conventional Color Shift Correction” as a third correction mode can be set. The user can set a desired correction mode by selecting the correction mode and pressing the OK button.

In a case “AI Color Shift Correction with Super-resolution Processing” is set, the CPU 301 executes the color shift correction process illustrated in the flowchart of FIG. 12 using the machine learning model 1300. In a case “AI Color Shift Correction without Super-resolution Processing” is set, the CPU 301 executes the color shift correction process illustrated in the flowchart of FIG. 12 using the machine learning model 500. In a case where “Conventional Color Shift Correction” is set, the CPU 301 executes a color shift correction process using a rule base. Under the rule base, a pixel of interest is corrected to be a pixel of a black edge portion in a case where the pixel of interest and the pixels preceding and following the pixel of interest represent “achromatic color, chromatic color, achromatic color” and the lightness of those three pixels satisfies a predetermined condition. This condition is: XL(−1)>XL(0)>XL(1); or XL(−1)<XL(0)<XL(1). “XL(−1)” denotes the lightness of the pixel preceding the pixel of interest. “XL(0)” denotes the lightness of the pixel of interest. “XL(1)” denotes the lightness of the pixel following the pixel of interest.

As described above, the CPU 301 is capable of switching between a color shift correction process using a machine learning model and a color shift correction process using a rule base according to the user's operation. Also, the CPU 301 is capable of executing a color shift correction process using different types of machine learning models according to the user's operation.

Note that each time the correction mode is switched, the CPU 301 may perform control to display an image corresponding to the correction mode on the UI screen 1800. In this case, the user can save the read image subjected to the color shift correction corresponding to an appropriate correction mode while checking the result of the correction.

In the above-described embodiments, the image processing unit 304 inside the reading apparatus 100 is caused to execute a machine learning model's process, but the present disclosure is not limited to this. A machine learning model's process may be executed outside the reading apparatus 100. For example, the learning apparatus 310 may be caused to execute the process.

In the above-described embodiments, the resolution with which a color shift correction process is executed is only the resolution of the low-resolution color scan mode but may be selected from among a plurality of resolutions. In this case, a learning process is performed for each of a plurality of resolutions at which the reading apparatus 100 is capable of performing reading, and sets of learned parameters corresponding to the respective resolutions are stored in the ROM 302. In the reading apparatus 100, the CPU 301 causes a machine learning model to execute a process using the set of learned parameters corresponding to the resolution with which the reading apparatus 100 will be caused to perform document reading among the plurality of resolutions at which the reading apparatus 100 is capable of performing reading.

In the above-described embodiments, CNN models are employed as machine learning models, but the present disclosure is not limited to this. For example, support vector machine (SVM) models may be employed as machine learning models. Alternatively, linear regression models may be employed as machine learning models. Alternatively, polynomial regression models may be employed as machine learning models. Note that the model parameters of the CNN models include a weight and a bias. The model parameters of the SVM models include a regularization parameter. The model parameters of the linear regression models include a slope and an intercept. The model parameters of the polynomial regression models include the coefficients of non-linear functions called basis functions. Note that the model parameters of the CNN models may include a model structure in addition to the weight and the bias. The model structure is information indicating the structure of the model such as the types and number of layers, as described earlier, but is not limited to this. For example, in a case where the types and number of layers of the CNN model and the like are fixed, the model structure may include the number of times to call (execute) that CNN model.

In the above-described embodiments, the CPU 301 of the reading apparatus 100 loads and obtains learned parameters stored in the ROM 302 in the reading apparatus 100, but the present disclosure is not limited to this. The CPU 301 of the reading apparatus 100 may load and obtain learned parameters stored outside the reading apparatus 100.

In the above-described embodiments, the reading apparatus 100 executes the color shift correction process, but the present disclosure is not limited to this. For example, an image processing apparatus connected to the reading apparatus 100 through a network or the like may execute the color shift correction process on the read image read by the reading apparatus 100. In this case, the image processing apparatus supplies the read image obtained by performing the color shift correction process to the reading apparatus 100.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to properly reduce a color shift.

This application claims the benefit of Japanese Patent Application No. 2025-063937, filed Apr. 8, 2025, which is hereby incorporated by reference herein in its entirety.

What is claimed is:

1. An image processing apparatus comprising:
one or more memories storing instructions; and
one or more processors which function as:
a reading control unit configured to control a reading apparatus to read a document;
a model execution unit configured to cause a machine learning model to execute a process using a learned parameter and taking a read image of a document as an input, wherein the learned parameter is a model parameter learned with an input image having a color shift and a correct image obtained by reducing a source image having a higher resolution than the input image; wherein the color shift results from a shift in reading position between light sources of a plurality of colors; and
an obtaining unit configured to obtain an image output from the machine learning model as a result of executing the process with the read image of the document as an input, the image output from the machine learning model being obtained as an image in which the color shift has been reduced as compared to the read image.

2. The image processing apparatus according to claim 1, wherein the model execution unit causes the machine learning model to execute the process by using the learned parameter corresponding to a reading resolution at which the reading control unit causes the reading apparatus to read the document among a plurality of learned parameters corresponding respectively to a plurality of resolutions at which the reading apparatus is capable of performing reading.

3. The image processing apparatus according to claim 1, wherein
the reading apparatus is capable of switching between a first scan mode in which the reading apparatus performs reading at a first resolution and a second scan mode in which the reading apparatus performs reading at a second resolution higher than the first resolution, and
the model execution unit causes the machine learning model to execute the process in a case where the first scan mode is executed, and does not cause the machine learning model to execute the process in a case where the second scan mode is executed.

4. The image processing apparatus according to claim 1, wherein the model execution unit causes, among the machine learning models corresponding respectively to a plurality of correction modes, the machine learning model corresponding to a selected one of the correction modes to execute the process.

5. The image processing apparatus according to claim 4, wherein the machine learning models corresponding respectively to the plurality of correction modes include an image generation model configured to output an image of a larger image size than an image size of an input, and an image generation model configured to output an image of a same image size as an image size of an input.

6. The image processing apparatus according to claim 1, wherein the resolution of the source image is set according to a reading width of a sensor included in the reading apparatus.

7. The image processing apparatus according to claim 1, wherein the resolution of the source image is at least two times the resolution of the input image.

8. The image processing apparatus according to claim 1, wherein the resolution of the source image is such a resolution that, in a range equivalent to one pixel, a range to be read by a sensor in a case where a first light source in an order of light emission emits light is included and is adjacent to or partly overlaps a range to be read by the sensor in a case where the light source emits light next.

9. The image processing apparatus according to claim 1, wherein the correct image is reduced to ½ of the source image or less.

10. The image processing apparatus according to claim 1, wherein the machine learning model is a model configured to output an image of a larger image size than an image size of the input image.

11. The image processing apparatus according to claim 1, wherein the input image and the source image are captured through the reading apparatus.

12. The image processing apparatus according to claim 1, wherein the input image and the correct image are created from the source image by a simulator.

13. The image processing apparatus according to claim 12, wherein the simulator creates the input image and the correct image by calculating pixels equivalent to a resolution at which the reading apparatus performs reading from source image data.

14. The image processing apparatus according to claim 12, wherein the machine learning model is a model initially trained using data including image data created by the simulator and subsequently trained using data including the source image or image data obtained by reducing the source image.

15. An image processing method comprising:
controlling a reading apparatus to read a document;
causing a machine learning model to execute a process using a learned parameter and taking a read image of a document as an input, wherein the learned parameter is a model parameter learned with an input image having a color shift and a correct image obtained by reducing a source image having a higher resolution than the input image; wherein the color shift results from a shift in reading position between light sources of a plurality of colors; and
obtaining an image output from the machine learning model as a result of executing the process with the read image of the document as an input, the image output from the machine learning model being obtained as an image in which the color shift has been reduced as compared to the read image.

16. A non-transitory computer readable storage medium storing a program for causing a computer to perform an image processing method, the image processing method comprising:
controlling a reading apparatus to read a document;
causing a machine learning model to execute a process using a learned parameter and taking a read image of a document as an input, wherein the learned parameter is a model parameter learned with an input image having a color shift and a correct image obtained by reducing a source image having a higher resolution than the input image; wherein the color shift results from a shift in reading position between light sources of a plurality of colors; and
obtaining an image output from the machine learning model as a result of executing the process with the read image of the document as an input, the image output from the machine learning model being obtained as an image in which the color shift has been reduced as compared to the read image.
